(19) United States
(12) Patent Application Publication
(10) Pub. No.: US 2017/0362731 A1
(43) Pub. Date: Dec. 21, 2017

(54) PLATABLE RESIN COMPOSITIONS

(71) Applicant: SABIC Global Technologies B.V., Bergen op Zoom (NL)

(72) Inventors: Huanbing WANG, Shanghai (CN); Pei Helen SUN, Shanghai (CN); Dake SHEN, Shanghai (CN); Yangang YAN, Shanghai (CN); Xiaofeng YU, Shanghai (CN)

(73) Assignee: SABIC Global Technologies B.V., Bergen op Zoom (NL)

(21) Appl. No.: 15/538,885

(22) PCT Filed: Dec. 21, 2015
(86) PCT No.: PCT/IB2015/059850

§ 371 Date: Jun. 22, 2017

Related U.S. Application Data
(60) Provisional application No. 62/096,236, filed on Dec. 23, 2014.

(51) Int. Cl. C25D 5/56; C08L 69/00

(52) U.S. Cl. CPC C25D 5/56; C08L 69/00

(57) ABSTRACT

Disclosed are platable resin compositions for use in, for example, metal plating of plastics. The resin compositions include polycarbonate, acrylonitrile butadiene styrene and a filler, and may exclude a laser direct structuring additive. The compositions possess markedly improved characteristics, such as notched IZOD impact, flex modulus, and peel strength. Also disclosed are methods for plating metal on a substrate that is formed from the present resin compositions, as well as articles that include the disclosed compositions.

### RELATED APPLICATIONS

This application claims benefit of U.S. Patent Application No. 62/096,236 filed on Dec. 23, 2014, the disclosure of which is incorporated herein by reference in its entirety.

### TECHNICAL FIELD

The present disclosure pertains to polycarbonate-based resin compositions that can serve as substrates for metal plating.

### BACKGROUND

Plastic parts can be coated with metals for aesthetic, mechanical, and other purposes. U.S. Pat. Nos. 3,556,955, 3,896,252, 3,550,315, 5,153,023, and 5,462,773 describe previously identified processes for metal plating of polymers.

Desirable properties for substrate resins include peel strength, impact modulus, flow, tensile strength, heat deflection temperature (HDT), tensile strength, and ductility.

Resins for use as substrates in plating processes are commercially available. Certain unfilled polymers, such as acrylonitrile-butadiene-styrene (ABS), polycarbonate, polyimides, and other similar compositions can be surface treated for plating. However, there remains an ongoing need for new resins for metal plating that display enhanced properties and can thereby be used to form superior metal-plated plastic products for consumer electronics, fashion items, and other goods requiring lightweight but durable components.

### SUMMARY

Disclosed are platable resin compositions comprising 10-90 wt % of polycarbonate, 5-50% of acrylonitrile butadiene styrene, and, 1-8% of a filler, wherein said resin composition does not include a laser direct structuring additive. In certain embodiments the filler is talc. The resin compositions, in some instances, do not include styrene acrylonitrile.

Also disclosed are methods for plating metal on a substrate comprising:

providing a substrate comprising a resin that includes 10-90 wt % of polycarbonate, 5-50% of acrylonitrile butadiene styrene, and, 1-8% of a filler, wherein the resin composition does not include a laser direct structuring additive, and, depositing a metal on the substrate, thereby plating the substrate with the metal.

The present disclosure also pertains to a plated resin that is produced according to the presently provided methods for plating metal on a substrate, as well as articles, such as electronic devices, that comprise such plated resins.

### DETAILED DESCRIPTION OF ILLUSTRATIVE EMBODIMENTS

It is to be understood that the terminology used herein is for the purpose of describing particular aspects only and is not intended to be limiting. As used in the specification and in the claims, the term “comprising” can include the embodiments “consisting of” and “consisting essentially of.” Unless defined otherwise, all technical and scientific terms used herein have the same meaning as commonly understood by one of ordinary skill in the art to which this disclosure belongs. In this specification and in the claims which follow, reference will be made to a number of terms which shall be defined herein.

As used in the specification and the appended claims, the singular forms “a,” “an” and “the” include plural equivalents unless the context clearly dictates otherwise. Thus, for example, reference to “a polycarbonate polymer” includes mixtures of two or more polycarbonate polymers.

As used herein, the term “combination” is inclusive of blends, mixtures, alloys, reaction products, and the like.

Ranges can be expressed herein as from one particular value, and/or to another particular value. When such a range is expressed, another aspect includes from the one particular value and/or to the other particular value. Similarly, when values are expressed as approximations, by use of the antecedent “about”, it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Disclosed are the components to be used to prepare the compositions of the disclosure as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the disclosure. Thus, if there are a variety of additional steps that can be performed it is understood that each of these additional steps can be performed with any specific aspect or combination of aspects of the methods of the disclosure.

References in the specification and concluding claims to parts by weight, of a particular element or component in a composition or article, denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

As used herein the terms “weight percent,” “wt. %,” and “wt. %” of a component, which can be used interchangeably, unless specifically stated to the contrary, are based on the total weight of the formulation or composition in which the component is included. For example if a particular element or component in a composition or article is said to have 8% by weight, it is understood that this percentage is relative to a total compositional percentage of 100% by weight.

As used herein, the terms “weight average molecular weight” or “Mw” can be used interchangeably, and are defined by the formula:

$${M}_{w} = \frac{\sum {N}_{i} {M}_{i}^{2}}{\sum {N}_{i} {M}_{i}} ,$$

where Mᵢ is the molecular weight of a chain and Ni is the number of chains of that molecular weight. Compared to Mₙ, M_{w} takes into account the molecular weight of a given chain in determining contributions to the molecular weight average. Thus, the greater the molecular weight of a given chain, the more the chain contributes to the M_{w}. M_{w} can be determined for polymers, e.g. polycarbonate polymers, by methods well known to a person having ordinary skill in the art using molecular weight standards, e.g. polycarbonate standards or polystyrene standards, preferably certified or traceable molecular weight standards.

All cited patents, patent applications, and other references are incorporated herein by reference in their entirety.

While typical embodiments have been set forth for the purpose of illustration, the foregoing descriptions should not be deemed to be a limitation on the scope herein. Accordingly, various modifications, adaptations, and alternatives can occur to one skilled in the art without departing from the spirit and scope herein.

### Polycarbonate Polymer

The terms “polycarbonate” or “polycarbonates” as used herein includes copolycarbonates, homopolycarbonates and (co)polyester carbonates.

The term polycarbonate can be further defined as compositions have repeating structural units of the formula (1):

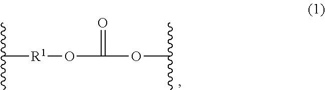

in which at least 60 percent of the total number of R¹ groups are aromatic organic radicals and the balance thereof are aliphatic, alicyclic, or aromatic radicals. In a further aspect, each R¹ is an aromatic organic radical and, more preferably, a radical of the formula (2):

-A¹-Y¹-A²- (2),

wherein each of A¹ and A² is a monocyclic divalent aryl radical and Y¹ is a bridging radical having one or two atoms that separate A¹ from A². In various aspects, one atom separates A¹ from A². For example, radicals of this type include, but are not limited to, radicals such as —O—, —S—, —S(O)—, —S(O₂)—, —C(O)—, methylene, cyclohexyl-methylene, 2-[2.2.1]-bicycloheptylidene, ethylidene, isopropylidene, neopentylidene, cyclohexylidene, cyclopentadecylidene, cyclododecylidene, and adamantylidene. The bridging radical Y¹ is preferably a hydrocarbon group or a saturated hydrocarbon group such as methylene, cyclohexylidene, or isopropylidene. Polycarbonate materials include materials disclosed and described in U.S. Pat. No. 7,786,246, which is hereby incorporated by reference in its entirety for the specific purpose of disclosing various polycarbonate compositions and methods for manufacture of the same.

In one aspect, a polycarbonate polymer as disclosed herein can be an aliphatic-diol based polycarbonate. In another aspect, the polycarbonate polymer can comprise a carbonate unit derived from a dihydroxy compound, such as, for example, a bisphenol that differs from the aliphatic diol. In still further aspects, an exemplary polycarbonate polymer includes aromatic polycarbonates conventionally manufactured through a transesterification reaction of an one or more aromatic dihydroxy compound(s) and a carbonic acid diester in the presence of one or more catalyst(s).

In one aspect, non-limiting examples of suitable bisphenol compounds include the following: 4,4′-dihydroxybiphenyl, 1,6-dihydroxynaphthalene, 2,6-dihydroxynaphthalene, bis(4-hydroxyphenyl)methane, bis(4-hydroxyphenyl)diphenylmethane, bis(4-hydroxyphenyl)-1-naphthylmethane, 1,2-bis(4-hydroxyphenyl)ethane, 1,1-bis(4-hydroxyphenyl)-1-phenylethane, 2-(4-hydroxyphenyl)-2-(3-hydroxyphenyl)propane, bis(4-hydroxyphenyl)phenylmethane, 2,2-bis(4-hydroxy-3-bromophenyl)propane, 1,1-bis(hydroxyphenyl)cyclopentane, 1,1-bis(4-hydroxyphenyl)cyclohexane, 1,1-bis(4-hydroxy-3 methylphenyl)cyclohexane 1,1-bis(4-hydroxyphenyl)isobutene, 1,1-bis(4-hydroxyphenyl)cyclododecane, trans-2,3-bis(4-hydroxyphenyl)-2-butene, 2,2-bis(4-hydroxyphenyl)adamantine, (alpha, alpha′-bis(4-hydroxyphenyl)toluene, bis(4-hydroxyphenyl)acetonitrile, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4-hydroxyphenyl)propane, 2,2-bis(3-allyl-4-hydroxyphenyl)propane, 2,2-bis(3-methoxy-4-hydroxyphenyl)propane, 2,2-bis(4-hydroxyphenyl)hexafluoropropane, 1,1-dichloro-2,2-bis(4-hydroxyphenyl)ethylene, 1,1-dibromo-2,2-bis(4-hydroxyphenyl)ethylene, 1,1-dichloro-2,2-bis(5-phenoxy-4-hydroxyphenyl)ethylene, 4,4′-dihydroxybenzophenone, 3,3-bis(4-hydroxyphenyl)-2-butanone, 1,6-bis(4-hydroxyphenyl)-1,6-hexanedione, ethylene glycol bis(4-hydroxyphenyl)ether, bis(4-hydroxyphenyl)ether, bis(4-hydroxyphenyl) sulfide, bis(4-hydroxyphenyl)sulfoxide, bis(4-hydroxyphenyl)sulfone, 9,9-bis(4-hydroxyphenyl)fluorene, 2,7-dihydroxypyrene, 6,6′-dihydroxy-3,3,3′,3′-tetramethylspiro(bis)indane (“spirobiindane bisphenol”), 3,3-bis(4-hydroxyphenyl)phthalide, 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, and 2,7-dihydroxycarbazole, and the like, as well as combinations comprising at least one of the foregoing dihydroxy aromatic compounds.

In another aspect, exemplary bisphenol compounds can comprise 1,1-bis(4-hydroxyphenyl)methane, 1,1-bis(4-hydroxyphenyl)ethane, 2,2-bis(4-hydroxyphenyl)propane (hereinafter “bisphenol A” or “BPA”), 2,2-bis(4-hydroxyphenyl)butane, 2,2-bis(4-hydroxyphenyl)octane, 1,1-bis(4-hydroxyphenyl)propane, 1,1-bis(4-hydroxyphenyl)n-butane, 2,2-bis(4-hydroxy-1-methylphenyl)propane, 1,1-bis(4-hydroxy-t-butylphenyl)propane, 3,3-bis(4-hydroxyphenyl)phthalimidine, 2-phenyl-3,3-bis(4-hydroxyphenyl)phthalimidine (“PPPBP”), and 9,9-bis(4-hydroxyphenyl)fluorene. Combinations comprising at least one dihydroxy aromatic compound can also be used. In another aspect, other types of diols can be present in the polycarbonate.

In a yet another aspect, polycarbonates with branching groups can be useful, provided that such branching does not significantly adversely affect desired properties of the polycarbonate. Branched polycarbonate blocks can be prepared by adding a branching agent during polymerization. These branching agents include polyfunctional organic compounds containing at least three functional groups selected from hydroxyl, carboxyl, carboxylic anhydride, haloformyl, and mixtures of the foregoing functional groups. Specific examples include trimellitic acid, trimellitic anhydride, trimellitic trichloride, tris-p-hydroxy phenyl ethane, isatin-bis-phenol, tris-phenol TC (1,3,5-tris((p-hydroxyphenyl)isopropyl)benzene), tris-phenol PA (4(4(1,1-bis(p-hydroxyphenyl)-ethyl) alpha, alpha-dimethylbenzyl)phenol), 4-chloroformyl phthalic anhydride, trimesic acid, and benzophenone tetracarboxylic acid. In one aspect, a branching agent can be added at a level of about 0.05 to about 2.0 wt %. In a still another aspect, mixtures comprising linear polycarbonates and branched polycarbonates can be used.

The polycarbonate polymer can comprise copolymers comprising carbonate units and other types of polymer units, including ester units, and combinations comprising at least one of homopolycarbonates and copolycarbonates. An exemplary polycarbonate copolymer of this type is a polyester carbonate, also known as a polyester-polycarbonate. Such copolymers further contain carbonate units derived from oligomeric ester-containing dihydroxy compounds (also referred to herein as hydroxy end-capped oligomeric acrylate esters). In another aspect, the polycarbonate does not comprise a separate polymer such as a polyester. In one aspect, an aliphatic-based polycarbonate comprises aliphatic units that are either aliphatic carbonate units derived from aliphatic diols, or a combination of aliphatic ester units derived from aliphatic diacids having greater than 13 carbons.

The polycarbonate may be present in the present resin compositions in an amount from 10 wt % to 90 wt %. In another aspect, the polycarbonate is present in an amount from 20 wt % to 80 wt %. In a yet further aspect, the polycarbonate is present in an amount from 40 wt % to 80 wt %. In another aspect, the polycarbonate is present in an amount of 60 wt % to 80 wt %. In another aspect, the polycarbonate is present in an amount of 65 wt % to 75 wt %. In another aspect, the polycarbonate is present in an amount of 65 wt % to 70 wt %. In another aspect, the polycarbonate is present in an amount of about 68 wt %.

### Acrylonitrile Butadiene Styrene (ABS)

In various aspects, the blended thermoplastic compositions comprise a high rubber graft acrylonitrile-butadiene-styrene (“HRG ABS”) polymer. HRG ABS polymers comprise greater than or equal to about 90% by weight SAN grafted onto polybutadiene, the remainder being free SAN. In some instances the free, ungrafted, SAN can be from 0 to 5 wt % of the HRG ABS composition. Some embodiments of the instant resin compositions do not contain any free SAN. Other embodiments of the instant compositions do not contain any SAN, whether free or grafted onto polybutadiene. ABS can have butadiene contents between 12% and 85% by weight and styrene to acrylonitrile ratios between 90:10 and 60:40.

In a further aspect, at least about 30% by weight of the rigid polymeric phase is chemically bound or grafted to the rubbery polymeric phase. In a still further aspect, at least about 45% by weight of the rigid polymeric phase is chemically bound or grafted to the rubbery polymeric phase.

In a further aspect, the HRG ABS has rubber content greater than or equal to about 50 wt % by weight of the graft polymer. In a still further aspect, the HRG ABS has rubber content greater than or equal to about 60 wt % by weight of the graft polymer.

In a further aspect, the HRG ABS has rubber content less than or equal to about 95 wt % by weight of the graft polymer. In a still further aspect, the HRG ABS has rubber content less than or equal to about 90 wt % by weight of the graft polymer.

In various aspects, the high rubber graft impact modifier is in the form of a core-shell polymer built up from a rubber-like core on which one or more shells have been grafted. The core therefore consists substantially of an acrylate rubber or a butadiene rubber, and the shell(s) preferably comprise a vinylaromatic compound and/or a vinylcyanide and/or an alkyl(meth)acrylate. The core and/or the shell(s) often comprise multi-functional compounds that may act as a cross-linking agent and/or as a grafting agent. These polymers are usually prepared in several stages.

In a further aspect, the HRG ABS comprises about 8 wt % acrylonitrile, about 43 wt % butadiene, and about 49 wt % styrene. In a still further aspect, the HRG ABS comprises about 7 wt % acrylonitrile, about 50 wt % butadiene and about 43 wt % styrene. In a still further aspect, the HRG ABS comprises about 7 wt % acrylonitrile, about 69 wt % butadiene and about 24 wt % styrene. In an even further aspect, the HRG ABS comprise 11.1 wt. % acrylonitrile and about 38.5 wt. % styrene grafted to about 51 wt. % polybutadiene with a crosslink density of 43-55%.

In a further aspect, the HRG ABS has a mean particle size of about 100 microns to about 500 microns. In a still further aspect, the HRG ABS has a mean particle size of about 200 microns to about 400 microns. In a yet further aspect, the HRG ABS has a mean particle size of about 250 microns to about 350 microns. In an even further aspect, the HRG ABS has a mean particle size of about 200 microns to about 500 microns. In a still further aspect, the HRG ABS has a mean particle size of about 100 microns. In a yet further aspect, the HRG ABS has a mean particle size of about 150 microns. In an even further aspect, the HRG ABS has a mean particle size of about 200 microns. In a still further aspect, the HRG ABS has a mean particle size of about 250 microns. In a yet further aspect, the HRG ABS has a mean particle size of about 300 microns. In an even further aspect, the HRG ABS has a mean particle size of about 350 microns. In a still further aspect, the HRG ABS has a mean particle size of about 400 microns. In a yet further aspect, the HRG ABS has a mean particle size of about 450 microns. In an even further aspect, the HRG ABS has a mean particle size of about 500 microns.

In various aspects, the HRG ABS are prepared by graft polymerizing less than about 50 wt % of at least one rigid monomer such as a vinyl aromatic monomer, an acrylic monomer, a vinyl nitrile monomer or a mixture thereof in the presence of more than about 50 wt % of a preformed rubbery polydiene substrate such as 1,3-diene polymer or copolymer thereof. In particular, the graft copolymers comprise from 50 wt % to 90 wt % of a rubbery substrate polydiene such as for example polybutadiene or polyisoprene or a copolymer of a 1,3-diene with less than about 50 wt % of a copolymerizable vinyl or vinylidene monomer such as for example an olefin, a styrene monomer, a (meth)acrylate ester monomer or a (meth)acrylonitrile monomer, and from 10 to 50 wt % of a rigid graft phase formed from at least one rigid vinylidene or vinyl monomer selected from the group consisting of vinyl aromatic monomers, (meth)acrylic monomers, vinyl nitrile monomers and mixtures thereof.

In the preparation of the high rubber graft copolymers, either or both the rubbery or the rigid graft component may further include minor amounts, less than about 5 wt % of a copolymerization crosslinking monomer(s) such as di- or tri-functional monomer or combinations thereof to increase graft linking or/and crosslinking of either or both components. Preferably, crosslinking monomer(s) are absent. The high rubber graft copolymers can be prepared by conventional polymerization processes including emulsion, suspension, sequential emulsion-suspension, bulk and solution polymerization processes. These methods are known in the polymerization art, specifically directed toward the preparation of a wide variety of high rubber graft copolymers for impact modification of thermoplastic resins. Suitable specific embodiments of the particular impact modifiers can be prepared by any aforementioned polymerization means. The preferred polymerization processes are in aqueous media and include emulsion and suspension methods. The preferred process for preparing the rubbery portion is by way of emulsion polymerization as taught in the art.

The rubber forms the backbone of the graft polymer, and is a polymer of a conjugated diene having the formula (XI):

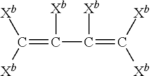

wherein X_{b} is hydrogen, C—C alkyl, chlorine, or bromine. Examples of dienes that may be used are butadiene, isoprene, 1,3-hepta-diene, methyl-1,3-pentadiene, 2,3-dimethyl-1,3-butadiene, 2-ethyl-1,3-pentadiene; 1,3- and 2,4-hexadienes, chloro and bromo substituted butadienes such as dichlorobutadiene, bromobutadiene, dibromobutadiene, mixtures comprising at least one of the foregoing dienes, and the like. A preferred conjugated diene is butadiene. Copolymers of conjugated dienes with other monomers may also be used, for example copolymers of butadiene-styrene, butadiene-acrylonitrile, and the like.

Alternatively, the backbone may be an acrylate rubber, such as one based on n-butyl acrylate, ethylacrylate, 2-ethylhexylacrylate, mixtures comprising at least one of the foregoing, and the like. Additionally, minor amounts of a diene may be copolymerized in the acrylate rubber backbone to yield improved grafting.

After formation of the backbone polymer, a grafting monomer is polymerized in the presence of the backbone polymer. One preferred type of grafting monomer is a monovinylaromatic hydrocarbon having the formula (XII):

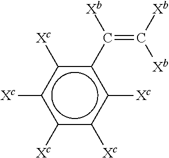

wherein X_{b} is as defined above and X_{c} is hydrogen, C1-C10 alkyl, C1-C10 cycloalkyl, C1-C10 alkoxy, C6-C18 alkyl, C6-C18 aralkyl, C6-C18 aryloxy, chlorine, bromine, and the like. Examples include styrene, 3-methylstyrene, 3,5-diethylstyrene, 4-n-propylstyrene, alpha-methylstyrene, alpha-methyl vinyltoluene, alpha-chlorostyrene, alpha-bromostyrene, dichlorostyrene, dibromostyrene, tetra-chlorostyrene, mixtures comprising at least one of the foregoing compounds, and the like. The preferred monovinylaromatic hydrocarbons are styrene and/or alpha-methylstyrene.

A second type of grafting monomer that may be polymerized in the presence of the polymer backbone are acrylic monomers of formula (XIII):

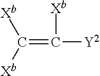

wherein X_{b} is as previously defined and Y² is cyano, C₁-C₁₂ alkoxycarbonyl, or the like. Examples of such acrylic monomers include acrylonitrile, ethacrylonitrile, methacrylonitrile, alpha-chloroacrylonitrile, beta-chloroacrylonitrile, alpha-bromoacrylonitrile, beta-bromoacrylonitrile, methyl acrylate, methyl methacrylate, ethyl acrylate, butyl acrylate, propyl acrylate, isopropyl acrylate, mixtures comprising at least one of the foregoing monomers, and the like. Preferred monomers include acrylonitrile, ethyl acrylate, and methyl methacrylate.

A mixture of grafting monomers may also be used, to provide a graft copolymer. In various aspects, mixtures comprise a monovinylaromatic hydrocarbon and an acrylic monomer. In a further aspect, graft copolymers include acrylonitrile-butadiene-styrene (ABS) and methyl methacrylate-butadiene-styrene (MBS) resins. Suitable high-rubber acrylonitrile-butadiene-styrene resins are available from SABIC Innovative Plastics as under the trade names BLENDEX™ grades 131, 336, 338, 360, and 415.

The ABS copolymer may be present in the present resin compositions in an amount from 5 wt % to 50 wt %. In another aspect, the ABS copolymer is present in an amount from 10 wt % to 40 wt %. In a yet further aspect, the ABS copolymer is present in an amount from 15 wt % to 25 wt %. In another aspect, the ABS copolymer is present in an amount of 20 wt % to 30 wt %. In another aspect, the ABS copolymer is present in an amount of 22 wt % to 28 wt %. In another aspect, the ABS copolymer is present in an amount of about 25 wt %.

### Fillers

Fillers or reinforcing agents may include, for example, mica, clay, feldspar, quartz, quartzite, perlite, tripoli, diatomaceous earth, aluminum silicate (mullite), synthetic calcium silicate, fused silica, fumed silica, sand, boron-nitride powder, boron-silicate powder, calcium sulfate, calcium carbonates (such as chalk, limestone, marble, and synthetic precipitated calcium carbonates) talc (including fibrous, modular, needle shaped, and lamellar talc), wollastonite, hollow or solid glass spheres, silicate spheres, cenospheres, aluminosilicate or (armospheres), kaolin, whiskers of silicon carbide, alumina, boron carbide, iron, nickel, or copper, continuous and chopped carbon fibers or glass fibers, molybdenum sulfide, zinc sulfide, barium titanate, barium ferrite, barium sulfate, heavy spar, TiO₂, aluminum oxide, magnesium oxide, particulate or fibrous aluminum, bronze, zinc, copper, or nickel, glass flakes, flaked silicon carbide, flaked aluminum diboride, flaked aluminum, steel flakes, natural fillers such as wood flour, fibrous cellulose, cotton, sisal, jute, starch, lignin, ground nut shells, or rice grain husks, reinforcing organic fibrous fillers such as poly(ether ketone), polyimide, polybenzoxazole, poly(phenylene sulfide), polyesters, polyethylene, aromatic polyamides, aromatic polyimides, polyetherimides, polytetrafluoroethylene, and poly(vinyl alcohol), as well combinations comprising at least one of the foregoing fillers or reinforcing agents. The fillers and reinforcing agents can be surface treated with silanes to improve adhesion and dispersion with the polymer matrix. Fillers may be included in the present resin compositions in the amount of 1 to 8% by weight. For example, fillers are present in the amount of about 1% by weight, about 2% by weight, about 3% by weight, about 4% by weight, about 5% by weight, about 6% by weight, about 7% by weight, or about 8% by weight. In one aspect, the filler is talc that is present in the resin composition in the amount of 3% by weight to 5% by weight. In another aspect, the filler is talc that is present in the resin composition in the amount of about 4% by weight. The talc may be surface modified, for example, with silanes.

### Additional Components

The resin compositions can further include an impact modifier that is in addition to or in combination with the acrylonitrile-butadiene-styrene component. Examples of impact modifiers include natural rubber, fluoroelastomers, ethylene-propylene rubber (EPR), ethylene-butene rubber, ethylene-propylene-diene monomer rubber (EPDM), acrylate rubbers, hydrogenated nitrile rubber (HNBR), silicone elastomers, styrene-butadiene-styrene (SBS), styrene-butadiene rubber (SBR), styrene-(ethylene-butene)-styrene (SEBS), acrylonitrile-ethylene-propylene-diene-styrene (AES), styrene-isoprene-styrene (SIS), styrene-(ethylene-propylene)-styrene (SEPS), methyl methacrylate-butadiene-styrene (MBS), high rubber graft (HRG), and the like. Some suitable impact modifies include PC(polycarbonate)/ABS (such as Cycoloy PC/ABS) and MBS type formulations.

The resin compositions can include an impact modifier, flow modifier, filler (e.g., a particulate polytetrafluoroethylene (PTFE), glass, carbon, mineral, or metal), reinforcing agent (e.g., glass fibers), antioxidant, heat stabilizer, light stabilizer, ultraviolet (UV) light stabilizer, UV absorbing additive, plasticizer, lubricant, release agent (such as a mold release agent), antistatic agent, anti-fog agent, antimicrobial agent, colorant (e.g, a dye or pigment), surface effect additive, radiation stabilizer, flame retardant, anti-drip agent (e.g., a PTFE-encapsulated styrene-acrylonitrile copolymer (TSAN)), or a combination comprising one or more of the foregoing. For example, a combination of a heat stabilizer, mold release agent, and ultraviolet light stabilizer can be used. In general, the additives are used in the amounts generally known to be effective. For example, the total amount of the additive composition (other than any impact modifier, filler, or reinforcing agent) can be 0.001 to 10.0 wt %, or 0.01 to 5 wt %, each based on the total weight of the polymer in the composition.

In addition to the polycarbonate, ABS, and filler, the thermoplastic composition can include various additives ordinarily incorporated into polymer compositions of this type, with the proviso that the additive(s) are selected so as to not significantly adversely affect the desired properties of the thermoplastic composition (good compatibility for example). Such additives can be mixed at a suitable time during the mixing of the components for forming the composition. Additives include reinforcing agents, antioxidants, heat stabilizers, light stabilizers, ultraviolet (UV) light stabilizers, plasticizers, lubricants, mold release agents, antistatic agents, colorants such as such as titanium dioxide, carbon black, and organic dyes, surface effect additives, radiation stabilizers, flame retardants, and anti-drip agents. A combination of additives can be used, e.g., a heat stabilizer, mold release agent, and ultraviolet light stabilizer. In general, the additives are used in the amounts generally known to be effective. For example, the total amount of the additives can be 0.01 to 5 wt. %, based on the total weight of the polycarbonate composition.

Heat stabilizer additives include organophosphites (e.g. triphenyl phosphite, tris-(2,6-dimethylphenyl)phosphite, tris-(mixed mono- and di-nonylphenyl)phosphite or the like), phosphonates (e.g, dimethylbenzene phosphonate or the like), phosphates (e.g., trimethyl phosphate, or the like), or combinations comprising at least one of the foregoing heat stabilizers. The heat stabilizer can be tris(2,4-di-t-butylphenyl) phosphate available as IRGAPHOS™ 168. Heat stabilizers are generally used in amounts of 0.01 to 5 wt %, based on the total weight of polymer in the composition.

There is considerable overlap among plasticizers, lubricants, and mold release agents, which include, for example, glycerol tristearate (GTS), phthalic acid esters (e.g, octyl-4,5-epoxy-hexahydrophthalate), tris-(octoxycarbonylethyl)isocyanurate, tristearin, di- or polyfunctional aromatic phosphates (e.g, resorcinol tetraphenyl diphosphate (RDP), the bis(diphenyl) phosphate of hydroquinone and the bis(diphenyl) phosphate of bisphenol A); poly-alpha-olefins; epoxidized soybean oil; silicones, including silicone oils (e.g., poly(dimethyl diphenyl siloxanes); esters, for example, fatty acid esters (e.g, alkyl stearyl esters, such as, methyl stearate, stearyl stearate, and the like), waxes (e.g, beeswax, montan wax, paraffin wax, or the like), or combinations comprising at least one of the foregoing plasticizers, lubricants, and mold release agents. These are generally used in amounts of 0.01 to 5 wt %, based on the total weight of the polymer in the composition.

Light stabilizers, in particular ultraviolet light (UV) absorbing additives, also referred to as UV stabilizers, include hydroxybenzophenones (e.g., 2-hydroxy-4-n-octoxy benzophenone), hydroxybenzotriazines, cyanoacrylates, oxanilides, benzoxazinones (e.g., 2,2′-(1,4-phenylene)bis(4H-3,1-benzoxazin-4-one, commercially available under the trade name CYASORB UV-3638 from Cytec), aryl salicylates, hydroxybenzotriazoles (e.g., 2-(2-hydroxy-5-methylphenyl)benzotriazole, 2-(2-hydroxy-5-tert-octylphenyl)benzotriazole, and 2-(2H-benzotriazol-2-yl)-4-(1,1,3,3-tetramethylbutyl)-phenol, commercially available under the trade name CYASORB 5411 from Cytec) or combinations comprising at least one of the foregoing light stabilizers. The UV stabilizers can be present in an amount of 0.01 to 1 wt %, specifically, 0.1 to 0.5 wt %, and more specifically, 0.15 to 0.4 wt %, based upon the total weight of polymer in the composition.

Antioxidant additives include organophosphites such as tris(nonyl phenyl)phosphite, tris(2,4-di-t-butylphenyl)phosphite, bis(2,4-di-t-butylphenyl)pentaerythritol diphosphite, distearyl pentaerythritol diphosphite; alkylated monophenols or polyphenols; alkylated reaction products of polyphenols with dienes, such as tetrakis[methylene(3,5-di-tert-butyl-4-hydroxyhydrocinnamate)] methane; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl)propionate, pentaerythrityl-tetrakis[3-(3,5-di-tert-butyl-4-hydroxyphenyl)propionate; amides of beta-(3,5-di-tert-butyl-4-hydroxyphenyl)-propionic acid, or combinations comprising at least one of the foregoing antioxidants. Antioxidants are used in amounts of 0.01 to 0.1 parts by weight, based on 100 parts by weight of the total composition, excluding any filler.

Useful flame retardants include organic compounds that include phosphorus, bromine, and/or chlorine. Non-brominated and non-chlorinated phosphorus-containing flame retardants can be preferred in certain applications for regulatory reasons, for example organic phosphates and organic compounds containing phosphorus-nitrogen bonds.

Inorganic flame retardants can also be used, for example salts of C₁₋₁₆ alkyl sulfonate salts such as potassium perfluorobutane sulfonate (Rimar salt), potassium perfluoroctane sulfonate, tetraethylammonium perfluorohexane sulfonate, and potassium diphenylsulfone sulfonate; salts such as Na₂CO₃, K₂CO₃, MgCO₃, CaCO₃, and BaCO₃, or fluoro-anion complexes such as Li₃AlF₆, BaSiF₆, KBF₄, K₃AlF₆, KAlF₄, K₂SiF₆, and/or Na₃AlF₆. When present, inorganic flame retardant salts are present in amounts of 0.01 to 10 parts by weight, more specifically 0.02 to 1 parts by weight, based on 100 parts by weight of the total composition, excluding any filler.

Anti-drip agents can also be used in the composition, for example a fibril forming or non-fibril forming fluoropolymer such as polytetrafluoroethylene (PTFE). The anti-drip agent can be encapsulated by a rigid copolymer, for example styrene-acrylonitrile copolymer (SAN). PTFE encapsulated in SAN is known as TSAN. A TSAN comprises 50 wt % PTFE and 50 wt % SAN, based on the total weight of the encapsulated fluoropolymer. The SAN can comprise, for example, 75 wt % styrene and 25 wt % acrylonitrile based on the total weight of the copolymer. Antidrip agents can be used in amounts of 0.1 to 10 parts by weight, based on 100 parts by weight of the total composition, excluding any filler.

The resin compositions can be manufactured by various methods known in the art. For example, powdered polycarbonate, ABS, filler, and other optional components are first blended, in a high speed mixer or by hand mixing. The blend is then fed into the throat of a twin-screw extruder via a hopper. Alternatively, at least one of the components can be incorporated into the composition by feeding it directly into the extruder at the throat and/or downstream through a sidestuffer, or by being compounded into a masterbatch with a desired polymer and fed into the extruder. The extruder is generally operated at a temperature higher than that necessary to cause the composition to flow. The extrudate can be immediately quenched in a water bath and pelletized. The pellets so prepared can be one-fourth inch long or less as desired. Such pellets can be used for subsequent molding, shaping, or forming.

Where a foam is desired, useful blowing agents include for example, low boiling halohydrocarbons and those that generate carbon dioxide; blowing agents that are solid at room temperature and when heated to temperatures higher than their decomposition temperature, generate gases such as nitrogen, carbon dioxide, and ammonia gas, such as azodicarbonamide, metal salts of azodicarbonamide, 4,4′ oxybis(benzenesulfonylhydrazide), sodium bicarbonate, ammonium carbonate, or the like, or combinations comprising at least one of the foregoing blowing agents.

### No Laser Direct Structuring Additives

The presently disclosed resin compositions do not include a laser direct structuring (LDS) additive. As used herein, a laser direct structuring additive refers to metal containing additives suitable for use in a laser direct structuring process. To that end, as discussed more fully herein, an LDS additive is selected such that, after activating with a laser, a conductive path can be formed by a subsequent standard metallization or plating process. As such, when the LDS additive is exposed to a laser, elemental metal is released or activated. The laser thus draws the circuit pattern onto the thermoplastic part and leaves behind a roughened surface containing embedded metal particles. These particles act as nuclei for the crystal growth during a subsequent metallization or plating process, such as a copper plating process or other plating processes, including gold plating, nickel plating, silver plating, zinc plating, tin plating or the like.

A laser direct structuring additive can comprise one or more metal oxides, including for example, oxides of chromium, copper, or combinations thereof. These laser direct structuring additives can also be provided having spinel type crystal structures. An exemplary and non-limiting example of a commercially available laser direct structuring additive includes PK3095 black pigment, commercially available from Ferro Corp., USA. The PK3095, for example, comprises chromium oxides (Cr₂O₃, Cr₂O₄²⁻, Cr₂O₇²⁻) and oxides of copper (CuO), as determined using XPS. The PK3095 black pigment also has a spinel type crystal structure. Another exemplary commercially available laser direct structuring additive is the Black 1G pigment black 28 commercially available from The Shepherd Color company. The Black 1G pigment black 28 comprises copper chromate and has a pH of about 7.3. The Black 1G pigment also has a spinel type crystal structure.

An LDS additive may comprise laser sensitive materials (e.g., at 1064 nm wavelength) including the metal oxide or salts of Sb, Cu, Pb, Ni, Fe, Sn, Cr, Mn, Ag, Au and Co. The LDS additive may comprise a copper chromium oxide spinel, a copper salt, a copper hydroxide phosphate, a copper phosphate, a copper sulfate, a cuprous thiocyanate, a spinel based metal oxide, a copper chromium oxide, an organic metal complex, a palladium/palladium-containing heavy metal complex, a metal oxide, a metal oxide-coated filler, antimony doped tin oxide coated on mica, a copper containing metal oxide, a zinc containing metal oxide, a tin containing metal oxide, a magnesium containing metal oxide, an aluminum containing metal oxide, a gold containing metal oxide, a silver containing metal oxide, or a combination thereof. Exemplary LDS additives include metal oxide containing copper, for example, copper chromium oxide spinel, copper hydroxide phosphate, and/or copper phosphate.

### Properties

The instant resin compositions are characterized by high impact strength (notched IZOD, 23° C., ASTM), high flex modulus (mm), and high peel strength (N/m) relative to conventional polycarbonate resin compositions used, for example, in processes for metal plating of polymers. These characteristics are present even while HDT, flex strength, MAI, and elongation are preserved.

In some embodiments, the present compositions have a notched IZOD of at least 600 J/m. In other embodiments, the compositions have a notched IZOD of at least 610 J/m. In still other embodiments, the compositions have a notched IZOD of at least 620 J/m. In other embodiments, the compositions have a notched IZOD of at least 630 J/m. In other embodiments, the compositions have a notched IZOD of at least 640 J/m. In other embodiments, the compositions have a notched IZOD of at least 650 J/m.

In some embodiments, the present compositions have a flex modulus of at least 1600 mm. In other embodiments, the compositions have a flex modulus of at least 1600 mm. In still other embodiments, the compositions have a flex modulus of at least 1650 mm. In other embodiments, the compositions have a flex modulus of at least 1700 mm. In other embodiments, the compositions have a flex modulus of at least 1750 mm. In other embodiments, the compositions have a flex modulus of at least 1800 mm. In other embodiments, the compositions have a flex modulus of at least 1850 mm. In other embodiments, the compositions have a flex modulus of at least 1900 mm.

In some embodiments, the present compositions have a peel strength of at least 3.0 N/m. In other embodiments, the compositions have a peel strength of at least 3.3 N/m. In still other embodiments, the compositions have a peel strength of at least 3.5 N/m. In other embodiments, the compositions have a peel strength of at least 3.7 N/m. In other embodiments, the compositions have a peel strength of at least 3.9 N/m. In other embodiments, the compositions have a peel strength of at least 4.0 N/m. In other embodiments, the compositions have a peel strength of at least 4.2 N/m. In other embodiments, the compositions have a peel strength of at least 4.4 N/m. In other embodiments, the compositions have a peel strength of at least 4.5 N/m. In other embodiments, the compositions have a peel strength of at least 4.7 N/m.

In some, embodiments, the present compositions have a notched IZOD of at least 620 J/m, a flex modulus of at least 1700 mm, and a peel strength of at least 3.5 N/m. In other embodiments, the compositions have a notched IZOD of at least 630 J/m, a flex modulus of at least 1750 mm, and a peel strength of at least 3.7 N/m. In other embodiments, the compositions have a notched IZOD of at least 640 J/m, a flex modulus of at least 1800 mm, and a peel strength of at least 3.9 N/m. In other embodiments, the compositions have a notched IZOD of at least 650 J/m, a flex modulus of at least 1850 mm, and a peel strength of at least 4.5 N/m.

### Methods

Also disclosed herein are methods for the plating of metal on a substrate comprising providing a substrate comprising a resin according to any of the above described embodiments, for example, that includes 10-90 wt % of polycarbonate, 5-50% of acrylonitrile butadiene styrene, and, 1-8% of a filler, wherein said resin composition does not include a laser direct structuring additive; and, depositing a metal on said substrate, thereby plating the substrate with the metal.

Any acceptable process for depositing the metal on the substrate may be used in accordance with the present methods. Numerous acceptable electroplating procedures, for example, are known among those skilled in the art and any such electroplating procedure may be used for depositing the metal on the substrate.

The metal that is deposited onto the substrate may be, for example, gold, nickel, tin, silver, zinc, copper, chrome, or any combination thereof.

### Articles of Manufacture

Also provided herein are metal-plated resins that are produced according to the above-described methods for the plating of metal on a substrate. In certain aspects, the metal-plated resin comprises a resin composition having a notched IZOD of at least 620 J/m, a flex modulus of at least 1700 mm, and a peel strength of at least 3.5 N/m, that is plated with gold, nickel, tin, silver, zinc, copper, chrome, or any combination thereof. In other embodiments, the metal-plated resin comprises a resin composition having a notched IZOD of at least 630 J/m, a flex modulus of at least 1750 mm, and a peel strength of at least 3.7 N/m that is plated with gold, nickel, tin, silver, zinc, copper, chrome, or any combination thereof. In other embodiments, the metal-plated resin comprises a resin composition having a notched IZOD of at least 640 J/m, a flex modulus of at least 1800 mm, and a peel strength of at least 3.9 N/m that is plated with gold, nickel, tin, silver, zinc, copper, chrome, or any combination thereof. In other embodiments, the metal-plated resin comprises a resin composition having a notched IZOD of at least 650 J/m, a flex modulus of at least 1850 mm, and a peel strength of at least 4.5 N/m that is plated with gold, nickel, tin, silver, zinc, copper, chrome, or any combination thereof. In any of the preceding embodiments, the resin may comprise 10-90 wt % of polycarbonate, 5-50% of acrylonitrile butadiene styrene, and, 1-8% of a filler, wherein said resin composition does not include a laser direct structuring additive.

Also disclosed herein are devices comprising any of the resin compositions described herein. Exemplary devices include, but are not limited to a housing or internal part for a television, notebook computer, laptop computer, personal computer, cellular phone, telephone, tablet, copier, printer, projector, automated teller machine, advanced media data storage device, memory device, air conditioner, vacuum cleaner, game machine, or power tool. In any of the preceding embodiments of devices, the resin composition may comprise 10-90 wt % of polycarbonate, 5-50% of acrylonitrile butadiene styrene, and, 1-8% of a filler, wherein said resin composition does not include a laser direct structuring additive.

### Aspects

In various aspects, the present disclosure pertains to and includes at least the following aspects.

Aspect 1. A platable resin composition comprising: 10-90 wt % of polycarbonate; 5-50% of acrylonitrile butadiene styrene; and, 1-8% of a filler, wherein said resin composition does not include a laser direct structuring additive.

Aspect 2. The resin composition according to aspect 1 comprising 20-80 wt % of said polycarbonate.

Aspect 3. The resin composition according to aspect 1 comprising 40-80 wt % of said polycarbonate.

Aspect 4. The resin composition according to aspect 1 comprising 60-80 wt % of said polycarbonate.

Aspect 5. The resin composition according to any one of aspects 1-4 comprising 20-30 wt % of said acrylonitrile butadiene styrene.

Aspect 6. The resin composition according to any one of aspects 1-5 comprising 3-5 wt % of said filler.

Aspect 7. The resin composition according to any one of aspects 1-5 comprising about 4 wt % of said filler.

Aspect 8. The resin composition according to any one of aspects 1-7 wherein said filler is talc, mica, milled glass fiber, glass fiber, glass flakes, glass beads, wollastonite, whiskers, carbon fiber, carbon powder, or milled carbon fiber, or a combination thereof.

Aspect 9. The resin composition according to any one of aspects 1-7, wherein said filler is talc.

Aspect 10. The resin composition according to any one of aspects 1-7, comprising about 4 wt % of talc.

Aspect 11. The resin composition according to any one of aspects 1-10 that does not include styrene acrylonitrile.

Aspect 12. The resin composition according to any one of aspects 1-11, further comprising an impact modifier, flow modifier, reinforcing agent, antioxidant, heat stabilizer, light stabilizer, ultraviolet light stabilizer, ultraviolet absorbing additive, plasticizer, lubricant, release agent, antistatic agent, anti-fog agent, antimicrobial agent, chain extender, colorant, de-molding agents, flow promoter, flow modifier, surface effect additive, radiation stabilizer, flame retardant, anti-drip agent, or any combination thereof.

Aspect 13. The resin composition according to any one of aspects 1-12, wherein said composition possesses a notched IZOD impact rating above 600 J/m, a flex modulus above 1550 mm, a peel strength above 3.0, or any combination thereof.

Aspect 14. The resin composition according to any one of aspects 1-13 that does not include any impact modifiers other than the acrylonitrile butadiene styrene.

Aspect 15. A method for the plating of metal on a substrate comprising: providing a substrate comprising a resin that includes 10-90 wt % of polycarbonate, 5-50% of acrylonitrile butadiene styrene, and, 1-8% of a filler, wherein said resin composition does not include a laser direct structuring additive; and, depositing a metal on said substrate, thereby plating said substrate with said metal.

Aspect 16. The method according to aspect 15 comprising 20-80 wt % of said polycarbonate.

Aspect 17. The method according to aspect 15 comprising 40-80 wt % of said polycarbonate.

Aspect 18. The method according to aspect 15 comprising 60-80 wt % of said polycarbonate.

Aspect 19. The method according to any one of aspects 15-18 comprising 20-30 wt % of said acrylonitrile butadiene styrene.

Aspect 20. The method according to any one of aspects 15-19 comprising 3-5 wt % of said filler.

Aspect 21. The method according to any one of aspects 15-20 comprising about 4 wt % of said filler.

Aspect 22. The method according to any one of aspects 15-21 wherein said filler is talc, mica, milled glass fiber, glass fiber, glass flakes, glass beads, wollastonite, whiskers, carbon fiber, carbon powder, or milled carbon fiber, or a combination thereof.

Aspect 23. The method according to any one of aspects 15-22, wherein said filler is talc.

Aspect 24. The method according to any one of aspects 15-23, comprising about 4 wt % talc.

Aspect 25. The method according to any one of aspects 15-24 that does not include styrene acrylonitrile.

Aspect 26. The method according to any one of aspects 15-25, further comprising an impact modifier, flow modifier, reinforcing agent, antioxidant, heat stabilizer, light stabilizer, ultraviolet light stabilizer, ultraviolet absorbing additive, plasticizer, lubricant, release agent, antistatic agent, anti-fog agent, antimicrobial agent, chain extender, colorant, de-molding agents, flow promoter, flow modifier, surface effect additive, radiation stabilizer, flame retardant, anti-drip agent, or any combination thereof.

Aspect 27. The method according to any one of aspects 15-26 wherein the metal is gold, nickel, tin, silver, zinc, copper, chrome, or any combination thereof.

Aspect 28. The method according to any one of aspects 15-27, wherein said resin composition possesses a notched IZOD impact rating above 600 J/m, a flex modulus above 1550 mm, a peel strength above 3.0, or any combination thereof.

Aspect 29. The method according to any one of aspects 15-28 wherein the resin composition does not include any impact modifiers other than the acrylonitrile butadiene styrene.

Aspect 30. A metal-plated resin that is produced according to the method of any one of aspects 15-29.

Aspect 31. An article comprising a metal-plated resin that is produced according to the method of any one of aspects 15-29.

Aspect 32. An article comprising a metal-plated resin, wherein said resin comprises 10-90 wt % of polycarbonate, 5-50 wt % of acrylonitrile butadiene styrene, and 1-8 wt % of a filler, wherein said resin composition does not include a laser direct structuring additive.

Aspect 33. The article according to aspect 32, wherein said resin composition possesses a notched IZOD impact rating above 600 J/m, a flex modulus above 1550 mm, a peel strength above 3.0, or any combination thereof.

Aspect 34. The article according to aspect 32 or 33 wherein the resin composition does not include any impact modifiers other than the acrylonitrile butadiene styrene.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.), but some errors and deviations should be accounted for. Unless indicated otherwise, parts are parts by weight, temperature is expressed in degrees Celsius or is at ambient temperature, and pressure is at or near atmospheric.

### Example 1—Composition and Properties Thereof

### Materials and Methods

For the data discussed herein the following materials and methods were used.

Table 1 describes the components from which the tested compositions were made:

TABLE 1

| No. | Item | Description | Supplier | Trade name |
|---|---|---|---|---|
| 1 | PC1 | BPA polycarbonate resin made by an | SABIC Innovative | LEXAN ™ |
| | | interfacial process with MVR at 300° | Plastics (“SABIC | |
| | | C./1.2 kg of about 5 to about 7 mL/10 | I.P.”) | |
| | | min and MW of about 29,900. | | |
| | | CAS No. 111211-39-3 | | |
| 2 | PC2 | BPA polycarbonate resin made by an | SABIC I.P | LEXAN ™ |
| | | interfacial process with MVR at 300° | | |
| | | C./1.2 kg of about 23 to about 30 | | |
| | | mL/10 min and Mw of about 21,800. | | |
| | | CAS No. 111211-39-3 | | |
| 3 | IM1 | High rubber graft emulsion | KUMHO | HR181 |
| | | polymerized ABS comprising about | PETROCHEMICAL | |
| | | 57 weight % polybutadiene | | |
| | | CAS No. 9003-56-9 | | |
| 4 | ADD1 | pentaerythritol | SHIPRO KASEI | SEENOX ® |
| | | betalaurylthiopropionate | KAISHA | 4125 |
| | | CAS No. 29598-76-3 | | |
| 5 | ADD2 | Pentaerythritol tetrastearate, a mold | FACI Farasco | PETS |
| | | release agent | Genova, Italy | |
| | | CAS No. 115-83-3 | | |
| 6 | ADD3 | Hindered phenol, Irganox 1076 | BASF | IRGANOX ® |
| | | CAS No. 2082-79-3 | | 1076 |
| 7 | ADD4 | Tris(2,4-di-tert-butylphenyl)phosphite, | BASF | IGRAFOS ® |
| | | stabilizer | | 168 |
| | | CAS No. 31570-04-4 | | |
| 8 | Fill1 | Hydrated Magnesium Silicate | LUZENAC | R7 |
| | | CAS No. 14807-96-6 | | Compacted |
| 9 | Fill2 | SGL SIGRAFIL ® C25 S006 PUT | SGL Carbon Group | SIGRAFIL ® |
| | | CAS No. 007440-44-0 | | C |

The notched IZOD impact of the tested compositions was determined by the ASTM D256 method at 23° C. at 50% humidity.

Flexural properties (modulus and strength) were measured using 6.4 mm or 3.2 mm bars in accordance with ASTM 790. Flexural strength at yield (“FS”) and flexural modulus (“FM”) are reported in units of MPa.

The peel strength of the tested compositions was determined by measurement under 2.5 mm strip width according to GMW 14668/ASTM B533-85 (2009).

The tested compositions were made under the following extrusion conditions. A TOSHIBA TEM37BS extruder was used having a screw diameter of 44 should be 37 mm. The extrusion temperature was 250° C. The screw speed was 200 should be 350 RPM. The molding of the composition was performed on a NISSEI ES3000 molding machine. The composition was pre-dried at 90° C. for 4 hrs. The barrel set up temperature from the nozzle was 240° C., 250° C., 250° C., 240° C., and 230° C. The molding temperature was 70° C.

### Results

Compositions made from the materials and methods discussed above were made with the following specifics and having the disclosed properties. The comparative examples demonstrate the improved properties of the disclosed compositions described herein.

Table 2 describes an exemplary composition and a comparative composition with observed properties, wherein amounts are expressed in terms of percentage by weight:

TABLE 2

| | | Comparative | Comparative |
|---|---|---|---|
| Component | Example 1 | Example 1 | Example 2 |
| 100 Grade PCP (PC1) | 10 | 10 | 10 |
| PCP 1300 (PC2) | 58.4 | 62.4 | 58.4 |
| Kumho HRG ABS (IM1) | 26.8 | 26.8 | 26.8 |
| Pentaerythritol | 0.2 | 0.2 | 0.2 |
| Betalaurylthiopropionate | | | |
| (ADD1) | | | |
| Hindered Phenol Antioxidant | 0.3 | 0.3 | 0.3 |
| (ADD3) | | | |
| Pentaerythritol Tetrastearate | 0.2 | 0.2 | 0.2 |
| (ADD2) | | | |
| Phosphite Stabilizer (ADD4) | 0.1 | 0.1 | 0.1 |
| Surface-Modified Talc (Fill2) | 4 | — | — |
| Carbon Fiber (Fill1) | — | — | 4 |
| Notched IZOD Impact | 635 | 592 | 259 |
| Elongation | 83.22 | 82.38 | 5.52 |
| Heat Distortion Temperature | 105 | 104 | 121 |
| (HDT) | | | |
| Flex Modulus | 1870 | 1530 | 2790 |
| Peel Strength | 4.5 | 2.7 | 7.3 |

Example 1 displayed excellent characteristics in terms of the notched IZOD impact, flex modulus, and peel strength. It is preferable for notched IZOD impact to be above 600 J/m, which indicates exceptional performance. It is desirable for flex modulus to be above 1550 mm, which indicates exceptional performance. It is also desirable for peel strength to be above 3.0, which indicates exceptional performance. The data indicates that the inclusion of surface modified talc in the specified amount produces a marked improvement in desired characteristics while maintaining other aspects of the desired performance of the resin composition. The inclusion of carbon fibers also produces an improvement in flex modulus and peel strength, but results in an unacceptable deterioration in notched IZOD impact and elongation.

1. A platable resin composition comprising:
10-90 wt % of polycarbonate;
5-50% of acrylonitrile butadiene styrene; and,
1-8% of a filler,
wherein said resin composition does not include a laser direct structuring additive, and
wherein a substrate formed the resin composition is capable of being plated with a metal.

2. The resin composition according to claim 1 comprising 60-80 wt % of said polycarbonate.

3. The resin composition according to claim 1 comprising 20-30 wt % of said acrylonitrile butadiene styrene.

4. The resin composition according to claim 1 comprising 3-5 wt % of said filler.

5. The resin composition according to claim 1 comprising about 4 wt % of talc.

6. The resin composition according to claim 1, wherein said composition possesses a notched IZOD impact rating above 600 J/m, a flex modulus above 1550 mm, a peel strength above 3.0, or any combination thereof.

7. The resin composition according to claim 1, wherein the resin composition does not include any impact modifiers other than the acrylonitrile butadiene styrene.

8. The resin composition according to claim 1, wherein the resin composition does not include styrene acrylonitrile.

9. The resin composition according to claim 1, further comprising an impact modifier, flow modifier, reinforcing agent, antioxidant, heat stabilizer, light stabilizer, ultraviolet light stabilizer, ultraviolet absorbing additive, plasticizer, lubricant, release agent, antistatic agent, anti-fog agent, antimicrobial agent, chain extender, colorant, de-molding agents, flow promoter, flow modifier, surface effect additive, radiation stabilizer, flame retardant, anti-drip agent, or any combination thereof.

10. A method for the plating of metal on a substrate comprising:
providing a substrate comprising a resin that includes
10-90 wt % of polycarbonate,
5-50% of acrylonitrile butadiene styrene, and,
1-8% of a filler,
wherein said resin composition does not include a laser direct structuring additive; and,
depositing a metal on said substrate, thereby plating said substrate with said metal.

11. The method according to claim 10 comprising 60-80 wt % of said polycarbonate.

12. The method according to claim 10 comprising 20-30 wt % of said acrylonitrile butadiene styrene.

13. The method according to claim 10 comprising 3-5 wt % of said filler.

14. The method according to claim 10, comprising about 4 wt % talc.

15. The method according to claim 10, wherein said resin possesses a notched IZOD impact rating above 600 J/m, a flex modulus above 1550 mm, a peel strength above 3.0, or any combination thereof.

16. The method according to claim 10, wherein the resin does not include any impact modifiers other than the acrylonitrile butadiene styrene.

17. The method according to claim 10 wherein the resin does not include styrene acrylonitrile.

18. The method according to claim 10, wherein the resin further comprises an impact modifier, flow modifier, reinforcing agent, antioxidant, heat stabilizer, light stabilizer, ultraviolet light stabilizer, ultraviolet absorbing additive, plasticizer, lubricant, release agent, antistatic agent, anti-fog agent, antimicrobial agent, chain extender, colorant, de-molding agents, flow promoter, flow modifier, surface effect additive, radiation stabilizer, flame retardant, anti-drip agent, or any combination thereof.

19. A metal-plated resin that is produced according to the method of claim 10.

20. An article comprising a metal-plated resin that is produced according to the method of claim 10.
